(19) United States
(12) Patent Application Publication
(10) Pub. No.: US 2024/0272901 A1
(43) Pub. Date: Aug. 15, 2024

(54) CONTROL DEVICE AND ADDRESS MANAGEMENT METHOD

(71) Applicant: Mitsubishi Electric Corporation, Tokyo (JP)

(72) Inventors: Marina KOUSAKA, Tokyo (JP); Tatsuya NAGATANI, Tokyo (JP)

(73) Assignee: Mitsubishi Electric Corporation, Tokyo (JP)

(21) Appl. No.: 18/569,606

(22) PCT Filed: Jun. 23, 2021
(86) PCT No.: PCT/JP2021/023756

§ 371 Date: Dec. 13, 2023

(51) Int. Cl. G06F 8/71

(52) U.S. Cl. CPC G06F 8/71

(57) ABSTRACT

It is an object to provide technology enabling efficient program development by a plurality of people. A control device includes a first memory to store a reference target after a change at a second address different from a first address of the reference target before the change. The control device includes a version manager to associate and manage the first address or the second address with each of a plurality of programs based on whether each of the plurality of programs is to reference the reference target before the change or the reference target after the change.

### TECHNICAL FIELD

The present disclosure relates to control devices and address management methods.

### BACKGROUND ART

As for a control device that controls a control target, technology enabling, before one person updates a program and transfers the updated program to the control device, determination on whether the last person who has updated the program to be transferred present in the control device is the one person or another person has been proposed (e.g., Patent Document 1). According to such a configuration, unnecessary overwriting of a program in the control device created by someone else can be suppressed.

### PRIOR ART DOCUMENTS

### Patent Document

Patent Document 1: Japanese Patent Application Laid-Open No. 2008-282362

### SUMMARY

### Problem to be Solved by the Invention

In the control device, however, after one person changes a library referenced by a program and transfers the changed library, the library is referenced by a program of another person, so that a conflict for the library occurs between the one person and the other person. As a result, in a case where the program of the other person references the library, the other person cannot change the program to cause a problem in that a program cannot efficiently be developed by a plurality of people.

The present disclosure has been conceived in view of a problem as described above, and it is an object of the present disclosure to provide technology enabling efficient program development by a plurality of people.

### Means to Solve the Problem

A control device according to the present disclosure is a control device that controls a control target according to a control program including a plurality of programs, and includes: a first memory to store, in a case where a reference target being a function or a library referenced by the plurality of programs is changed, the reference target after the change at a second address different from a first address of the reference target before the change; and a version manager to associate and manage the first address or the second address with each of the plurality of programs based on whether each of the plurality of programs is to reference the reference target before the change or the reference target after the change.

### Effects of the Invention

According to the present disclosure, the first address or the second address is associated and managed with each of the plurality of programs based on whether each of the plurality of programs is to reference the reference target before the change or the reference target after the change. A conflict for the library can thereby be suppressed to enable efficient program development by a plurality of people.

The objects, features, aspects and advantages of the present disclosure will become more apparent from the following detailed description when taken in conjunction with the accompanying drawings.

### BRIEF DESCRIPTION OF DRAWINGS

FIG. 1 is a diagram showing one example of an executable file.

FIG. 2 is a diagram for describing a code reader.

FIG. 3 is a diagram for describing a loader.

FIG. 4 is a diagram for describing the loader.

FIG. 5 is a schematic diagram showing a control device according to Embodiment 1.

FIG. 6 is a schematic diagram showing data content of ROM according to Embodiment 1.

FIG. 7 is a schematic diagram showing data content of executable files according to Embodiment 1.

FIG. 8 is a schematic diagram showing data content of a version management table according to Embodiment 1.

FIG. 9 is a schematic diagram showing data content of RAM according to Embodiment 1.

FIG. 10 is a schematic diagram showing data content of the ROM according to Embodiment 1.

FIG. 11 is a schematic diagram showing data content of the version management table according to Embodiment 1.

FIG. 12 is a schematic diagram showing data content of the RAM according to Embodiment 1.

FIG. 13 is a schematic diagram showing a control device according to Embodiment 2.

FIG. 14 is a schematic diagram showing data content of ROM according to Embodiment 2.

FIG. 15 is a schematic diagram showing data content of an identification data management table according to Embodiment 2.

FIG. 16 is a schematic diagram showing data content of a version information table according to Embodiment 2.

FIG. 17 is a schematic diagram showing data content of RAM according to Embodiment 2.

FIG. 18 is a schematic diagram showing data content of the ROM according to Embodiment 2.

FIG. 19 is a schematic diagram showing data content of the identification data management table according to Embodiment 2.

FIG. 20 is a schematic diagram showing data content of the version information table according to Embodiment 2.

FIG. 21 is a schematic diagram showing data content of the RAM according to Embodiment 2.

FIG. 22 is a schematic diagram showing a control device according to Embodiment 3.

FIG. 23 is a schematic diagram showing a control device according to Embodiment 4.

FIG. 24 is a schematic diagram showing a control device according to Embodiment 5.

### DESCRIPTION OF EMBODIMENTS

### Embodiment 1

A control device for a factory automation (FA) system used in a factory is programmable, and a dedicated engineering tool is used for development of a control program of the control device. The control program developed using the engineering tool is transferred to the control device, and the control device controls a control target according to the transferred control program.

The control program includes a plurality of individually executable programs and a function or a shared library referenced by the plurality of programs. The shared library is a library including a plurality of functions.

The control device has a function to update the control program during execution without powering down (also referred to as an online editing function) to improve working efficiency or an operating ratio. In a case where the engineering tool changes a program or the shared library and transfers the changed program or shared library to the control device, the control device having the above-mentioned function updates the program or the shared library of the control program based on the transferred program or shared library. Such an online editing function is used in various scenes, including those at adjustment accompanying installation of the control device during introduction into the factory, at addition of a new function to the FA system, and at version upgrading of a function.

On the other hand, with increased functionality and performance of the control device and diversified functionality of the FA system as a whole, a single control device often controls a plurality of control targets. People responsible for respective control target devices and functions create their programs using their engineering tools and transfer the created programs to the single control device to complete the control program. At online editing, for example, during introduction into the factory, people are required to fine adjust (change and transfer) and validate their programs so that the plurality of people can work efficiently.

In a case where a plurality of people perform online editing of programs they are responsible for, the plurality of people can work efficiently as their programs are independent of one another. In a case where online editing of the shared library is performed, however, there is a problem in that the plurality of people cannot work efficiently.

To describe a reason for the problem, processing until calling of the shared library during execution of the program by the control device and processing during online editing will be described below.

### Processing Until Calling of Shared Library

Processing until calling of the shared library during execution of the program by the control device will be described first. In this processing, the engineering tool transfers the program and the shared library to the control device, and the control device executes the program and the shared library. This processing will be described in detail below.

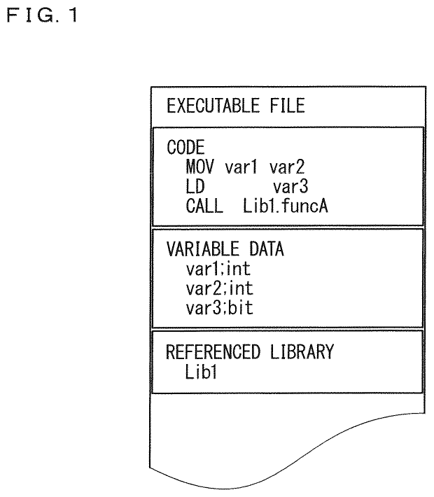

The engineering tool creates a file (hereinafter referred to as an executable file) as shown in FIG. 1 using a compiler. The executable file includes a code executable by the control device interpreting the program, variable data of variable information used in the program, and a name of the shared library referenced by the program. The executable file corresponds to a program of each person included in the control program, so that description will be made below based on the assumption that the executable file and the program of each person included in the control program are substantially the same.

The engineering tool transfers the executable file and the shared library to the control device. The control program includes a plurality of programs, so that a plurality of executable files corresponding to the respective programs are transferred from engineering tools to the control device.

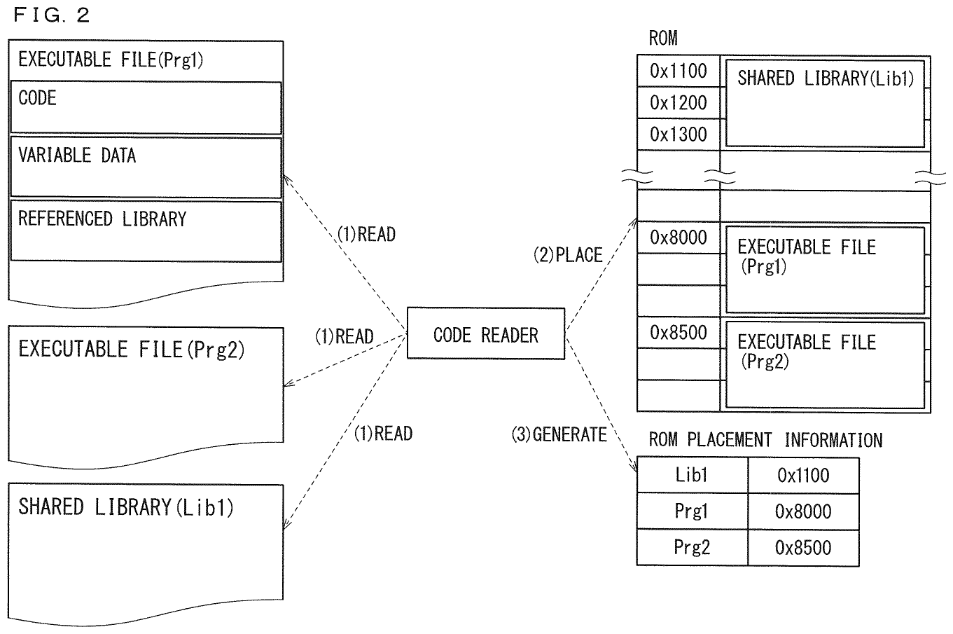

As shown in FIG. 2, a code reader of the control device reads the executable files and the shared library transferred from the engineering tools and places the read executable files and shared library in a read only memory (ROM). In Embodiment 1, placing information in a memory, such as a ROM and a RAM, is substantially the same as storing the information in the memory.

Next, the code reader generates ROM placement information in which names of the executable files and a name of the shared library are associated with ROM addresses of the executable files and a ROM address of the shared library. Description will be made below based on the assumption that, in a case where the shared library or the like is placed across a storage region of a plurality of ROM addresses, the shared library or the like is associated with a starting ROM address of the plurality of ROM addresses, but the shared library or the like may not be associated with the starting ROM address.

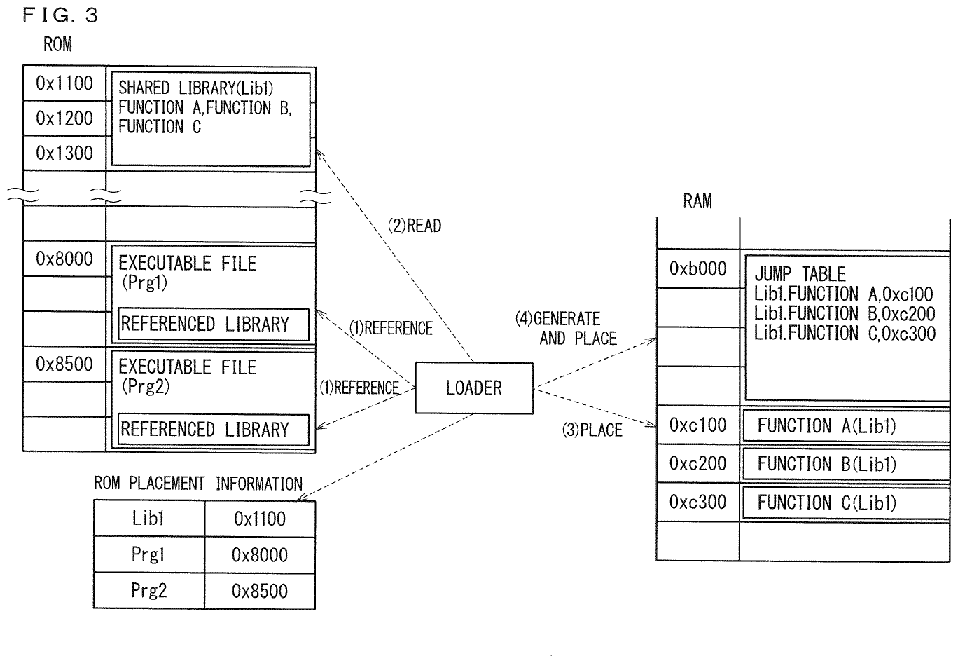

Then, as shown in FIG. 3, a loader of the control device reads, with reference to each of the executable files transferred from the engineering tools and placed in the ROM, information on the shared library referenced by the executable file. The loader places the shared library referenced by the executable file in a random access memory (RAM) based on the read information on the shared library. The loader generates a jump table in which a starting address of the RAM at which each function included in the shared library is placed is described and places the jump table in the RAM.

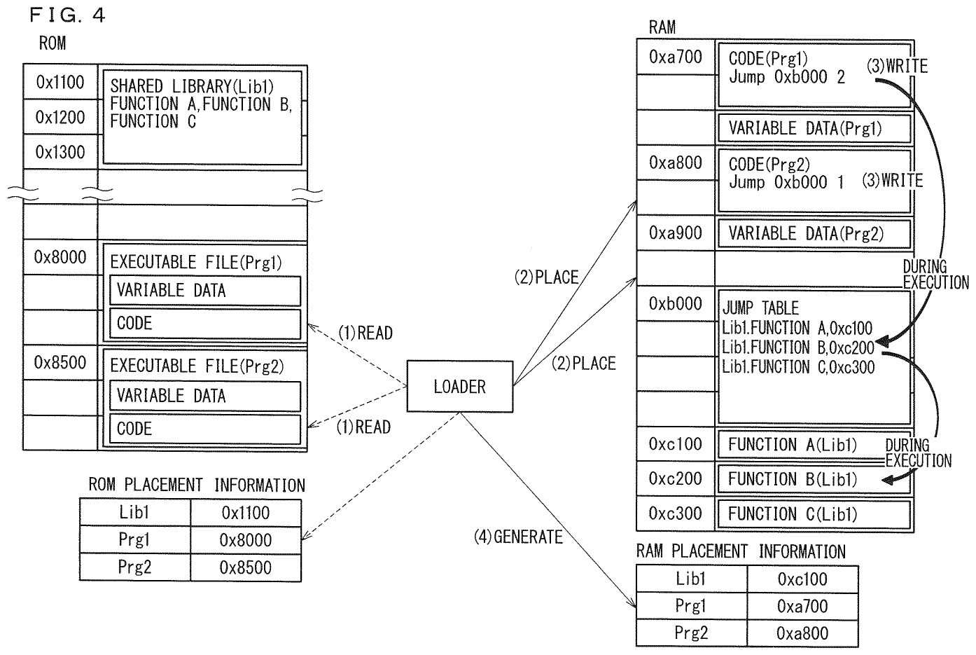

Then, as shown in FIG. 4, the loader reads each of the executable files placed in the ROM and places the code and conversion data included in the executable file in the RAM. In this case, the loader writes an address to the jump table into the code of each of the executable files so that the executable file can reference the jump table.

Finally, the loader generates RAM placement information based on the ROM placement information and RAM addresses of the executable files and a RAM address of the shared library. In the RAM placement information, the names of the executable files and the name of the shared library are associated with the RAM addresses of the executable files and the RAM address of the shared library. Description will be made below based on the assumption that, in a case where the shared library or the like is placed across a storage region of a plurality of RAM addresses, the shared library or the like is associated with a starting RAM address of the plurality of RAM addresses, but the shared library or the like may not be associated with the starting RAM address.

An unillustrated executor of the control device reads and executes the code of each of the executable files placed in the RAM. Jump instructions specifying an element of the jump table are described in the code, and the executor performs jumping to an address of a function of the shared library and executes the function with reference to the specified element of the jump table. For example, in a case where the executor reads “Jump 0xb000 2” in a code (Prg1) in FIG. 4, the executor executes a function B placed at “0xc200” with reference to “Lib1. function B, 0xc200” as an element “2” of the jump table placed at a RAM address “0xb000”. As described above, the control device can reference the shared library during execution of the program.

### Processing During Online Editing

Processing during online editing will be described next. A change of the program and a change of the shared library are made individually during online editing. A case where the program is changed will be described first, and then a case where the shared library is changed will be described.

### Processing During Online Editing (Change of Program)

The engineering tool transfers the executable file after the change. The code reader of the control device determines, for the transferred executable file, whether data content of the executable file placed in the control device and data content of the executable file of the engineering tool before the change (before the transfer) match. The code reader does not accept the transfer of the executable file after the change when determining that they do not match and accepts the transfer of the executable file after the change when determining that they match.

Next, the code reader places the executable file whose transfer has been accepted in the ROM. The executable file before the change previously placed in the ROM is disabled by overwriting and the like when the executable file after the change is placed in the ROM.

Then, the loader of the control device determines, based on the RAM placement information, whether the shared library referenced by the executable file after the change is already placed in the RAM. The loader writes an address to a jump table of the shared library determined to be already placed into the code of the executable file when determining that the shared library is already placed. The loader changes the code and the variable data of the executable file before the change placed in the RAM into the code and the variable data of the executable file after the change.

When determining that the shared library is not already placed, the loader places the shared library in the RAM, adds the shared library to the jump table, and then writes an address to the jump table of the added shared library into the code of the executable file. As a result, the executable file can reference the jump table of the shared library.

Finally, the loader updates the RAM placement information.

### Processing During Online Editing (Change of Shared Library)

The engineering tool transfers the shared library after the change to the control device. The code reader of the control device determines, for the transferred shared library, whether data content of the shared library placed in the control device and data content of the shared library of the engineering tool before the transfer (before the change) match. The code reader does not accept the transfer of the shared library after the change when determining that they do not match and accepts the transfer of the shared library after the change when determining that they match.

Next, the code reader places the shared library whose transfer has been accepted in the ROM. The shared library before the change previously placed in the ROM is disabled by overwriting and the like when the shared library after the change is placed in the ROM.

Then, the loader of the control device determines, based on the RAM placement information, whether the shared library after the change is already placed in the RAM. When determining that the shared library is already placed, the loader deletes the shared library before the change placed in the RAM, places the shared library after the change in the RAM, updates the jump table, and updates the RAM placement information. When determining that the shared library is not already placed, the loader may do nothing or may add the shared library to the RAM as in processing until reading of the shared library.

When the shared library during online editing is changed, the jump table is updated, so that all the programs referencing the shared library before the change are to reference the shared library after the change. That is to say, in a case where one person changes the shared library and transfers the changed shared library to the control device, a program of another person is to reference the shared library after the change.

The change of the shared library includes addition or deletion of an argument, so that the program referencing the shared library is sometimes required to be changed depending on the change of the shared library. In this case, to complete the change of the shared library, the one person sometimes transfers an executable file of the program of the other person referencing the shared library to the control device along with the shared library. The transfer causes a problem in that, when the other person thereafter tries to update and transfer the executable file the other person is responsible for, the transfer is not accepted as the executable file tried to be transferred does not match the executable file placed in the control device.

Thus, in a case where one person changes and transfers the shared library during online editing by a plurality of people, all the plurality of people responsible for programs referencing the shared library are required to suspend work and share the latest version of the shared library in some way. This is because the plurality of people cannot fine adjust the programs they are responsible for without knowing the shared library after the change. As described above, in a case where one person changes an argument and transfers the executable file of the program of the other person, the other person cannot continue work as the transfer of the executable file of the other person is not accepted. As a result of the foregoing, there is a problem in that a program cannot efficiently be developed by a plurality of people.

The control device according to Embodiment 1 enables efficient program development by a plurality of people as will be described below.

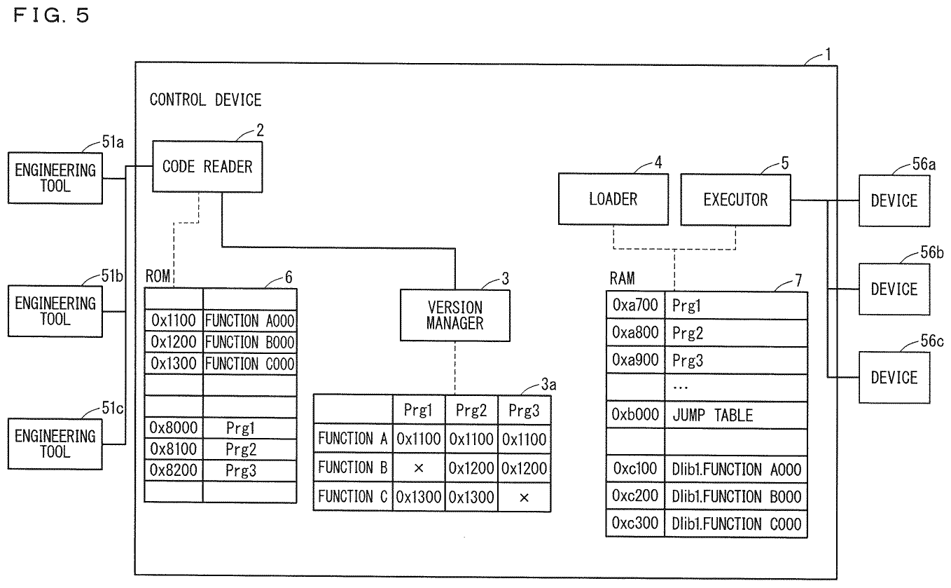

FIG. 5 is a schematic diagram showing a control device 1, engineering tools 51a to 51c, and devices 56a to 56c as control targets according to Embodiment 1.

A single control device 1 is connected to the engineering tools 51a to 51c and the devices 56a to 56c. The engineering tools 51a to 51c are used by respective workers to create a control program to control the devices 56a to 56c and fine adjust the control program while checking operation of a device 56 by online editing. The control program includes a plurality of programs corresponding to a plurality of executable files and a shared library referenced by the plurality of programs as with the above-mentioned control program. In description made below, the engineering tools 51a to 51c are referred to as an engineering tool 51 when not being distinguished from one another, and the devices 56a to 56c are referred to as the device 56 when not being distinguished from one another for the sake of convenience.

The control device 1 in FIG. 5 includes a code reader 2, a version manager 3, a loader 4, an executor 5, ROM 6, and RAM 7. The code reader 2, the version manager 3, the loader 4, and the executor 5 may be achieved by cooperation between hardware, such as an unillustrated central processing unit (CPU) and a memory of the control device 1, and software, such as a control program to control operation of the control device 1, or may be achieved by dedicated hardware, such as a processing circuit.

Each of the components during online editing will mainly be described below.

The code reader 2 is similar to the above-mentioned code reader. The code reader 2 determines, for the transferred executable file, whether data content of the executable file placed in the control device 1 and data content of the executable file of the engineering tool 51 before the change (before the transfer) match. Similarly, the code reader 2 determines, for the transferred shared library, whether data content of the shared library placed in the control device 1 and data content of the shared library of the engineering tool 51 before the change (before the transfer) match.

The code reader 2 accepts the transfer of the executable file or the shared library determined to match from the engineering tool 51. The code reader 2 then places the executable file or the shared library transferred from the engineering tool 51 in the ROM 6.

In a case where a reference target referenced by the plurality of programs is changed, the ROM 6 as a first memory stores the reference target after the change at a second address different from a first address of the reference target before the change. The reference target referenced by the plurality of programs may be a function or the shared library.

In a case where the shared library referenced by the plurality of programs is changed, the ROM 6 as described above places the shared library before the change and the shared library after the change at different addresses to enable both the shared libraries. In description made below, the first address of the ROM 6 at which the shared library before the change is placed is also referred to as a “ROM address before the change”, and the second address of the ROM 6 at which the shared library after the change is placed is also referred to as a “ROM address after the change”.

The code reader 2 updates the ROM placement information based on placement of the executable file or the shared library in the ROM 6.

The version manager 3 updates a version management table 3a based on a name of the executable file of a program the engineering tool 51 having transferred the changed shared library is responsible for and the ROM placement information. In the version management table 3a, a single address is herein associated with a pair of the name of the executable file of the program unique to the engineering tool 51 and a name of the function of the shared library.

The version manager 3 uses the version management table 3a to manage, for each executable file unique to the engineering tool 51 and for each function of the shared library referenced by the executable file, a starting address of the ROM 6 at which the function is placed.

The version manager 3 can thus associate and manage the ROM address before the change or the ROM address after the change with each of the plurality of programs based on whether each of the plurality of programs is to reference the shared library (or the functions) before the change or the shared library (or the functions) after the change. In a case where a first program is to reference the shared library before the change, for example, the version manager 3 associates and manages the ROM address before the change with the first program. In a case where a second program is to reference the shared library after the change, for example, the version manager 3 associates and manages the ROM address after the change with the second program.

The loader 4 is similar to the above-mentioned loader. A file name of the executable file or the shared library transferred from the engineering tool 51 and the ROM placement information are input into the loader 4.

In a case where the shared library is input, the loader 4 retrieves the shared library from the ROM 6 based on the ROM placement information and places the shared library in the RAM 7 as a second memory. In Embodiment 1, in a case where the shared library referenced by the plurality of programs is changed, the shared library before the change and the shared library after the change are placed at different addresses of the RAM 7 as with the ROM 6 to enable both the shared libraries. The loader 4 adds a starting address of each function of the shared library placed in the RAM 7 to the jump table. The loader 4 also writes an address of the jump table after the update into the code of the executable file of the program the engineering tool 51 having transferred the shared library is responsible for and the loader 4 updates the RAM placement information.

In a case where the executable file is input, the loader 4 writes the address of the jump table into the code of the executable file so that the function the executable file is to reference can be referenced based on the version management table 3a and the RAM placement information. The loader 4 also changes the code and the variable data of the executable file before the change placed in the RAM 7 into the code and the variable data of the executable file after the change and updates the RAM placement information.

The executor 5 is similar to the above-mentioned executor. The executor 5 performs processing of outputting a command to the device 56 based on the code, the variable data, and the shared library stored in the RAM 7, for example.

### Operation

Operation of the control device 1 according to Embodiment 1, that is, address management performed by the control device 1 will be described next.

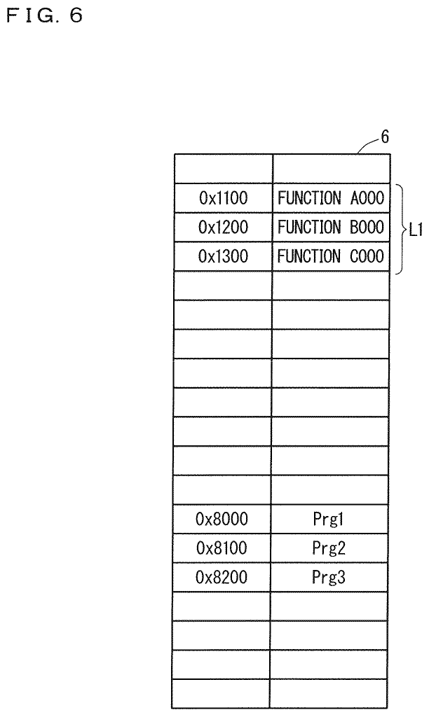

FIG. 6 is a schematic diagram showing data content of the ROM 6 in the control device 1 before online editing. A shared library L1 before the change including functions A to C before the change are placed in the ROM 6 with an address “0x1100” as a starting address, and executable files Prg1, Prg2, and Prg3 are placed in the ROM 6 with addresses “0x8000”, “0x8100”, and “0x8200” as starting addresses.

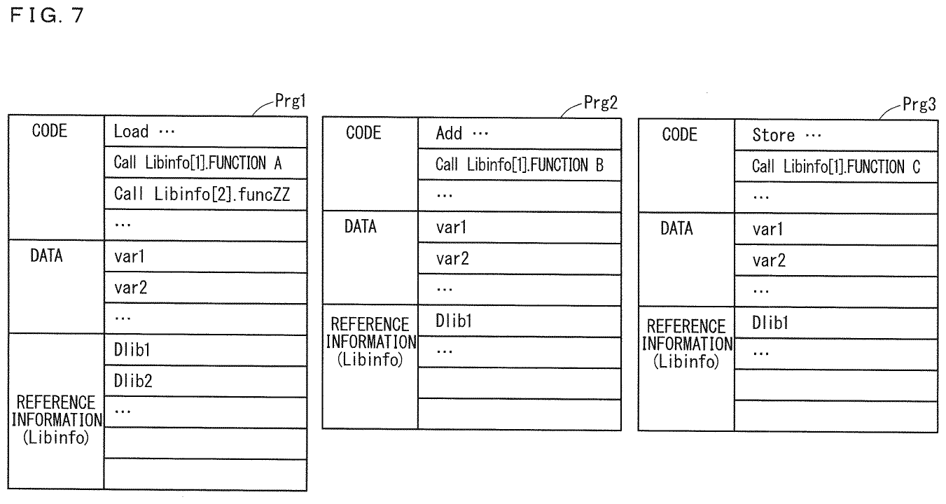

FIG. 7 is a schematic diagram showing data content of the executable files Prg1 to Prg3. In codes of the executable files Prg1 to Prg3, numbers of the shared library and functions to be referenced by programs of the executable files Prg1 to Prg3 are specified. While the executable files Prg1, Prg2, and Prg3 reference the functions A, B, and C on a one-to-one basis in an example of FIG. 7, a case where each of the executable files Prg1 to Prg3 references the functions A to C will be described below in contrast to the example of FIG. 7.

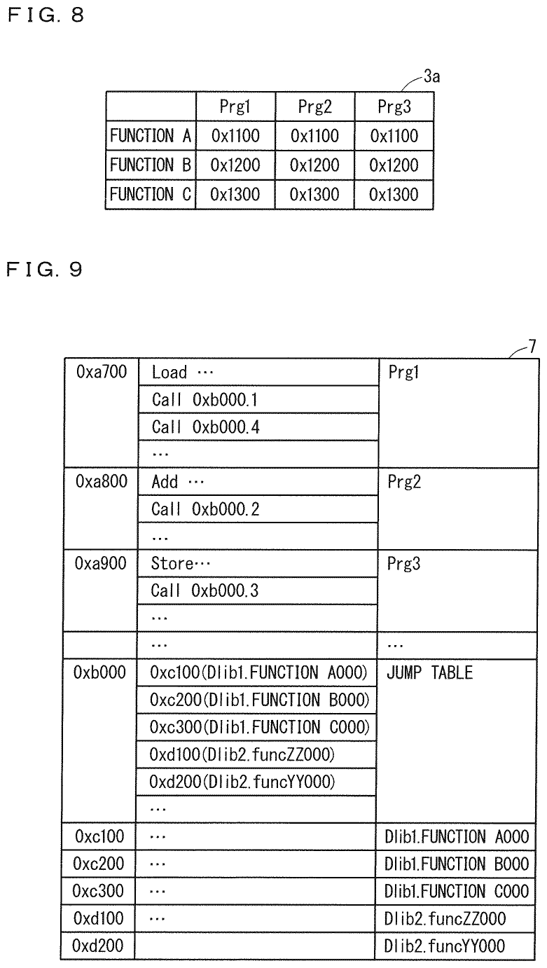

FIG. 8 is a schematic diagram showing data content of the version management table 3a before online editing. Starting addresses of the ROM 6 at which the functions referenced by the programs are placed are stored in the version management table 3a. Specifically, the starting addresses of the ROM 6 at which the functions to be referenced by the programs are placed are associated with the executable files Prg1 to Prg3 in the version management table 3a. The functions to be referenced by the programs of the executable files Prg1 to Prg3 in FIG. 8 are the shared library (or the functions) before online editing. The same version of the shared library and the functions is to be referenced before online editing, so that one address is associated with one function regardless of the executable files. That is to say, as in an example of FIG. 8, an address of the function A is “0x1100”, an address of the function B is “0x1200”, and an address of the function C is “0x1300” for each of the executable files Prg1 to Prg3.

FIG. 9 is a schematic diagram showing data content of the RAM 7 in the control device 1 before online editing. As for the function of the shared library set in each of the codes of the executable files Prg1 to Prg3, a starting address “0xb000” of the jump table and an offset value (an element of the jump table) of the function are written into each of the codes in FIG. 9 by the loader 4.

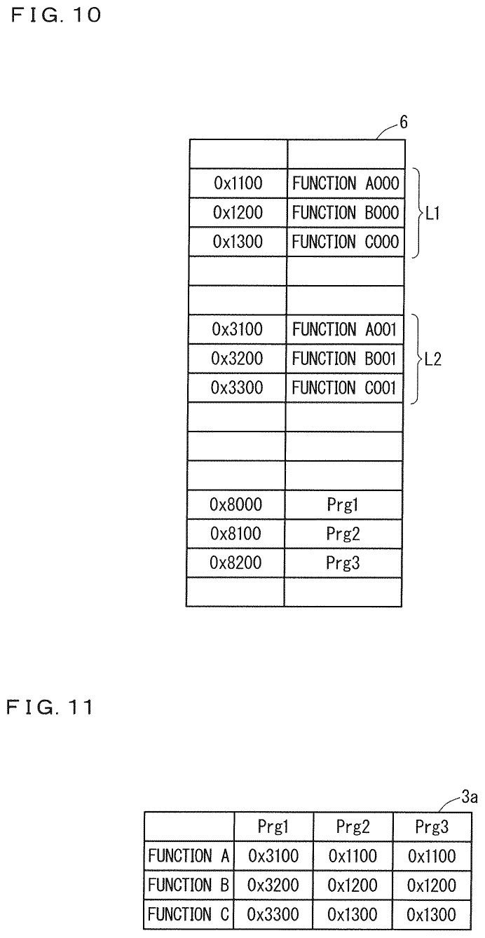

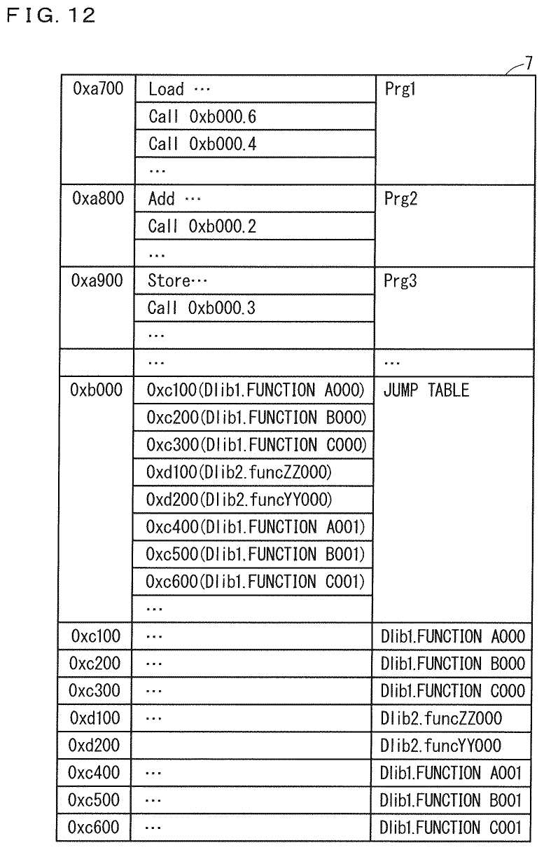

FIG. 10 is a schematic diagram showing data content of the ROM 6 in a case where the engineering tool 51a changes the function A of the shared library L1 and transfers the changed function A to the control device 1. FIGS. 11 and 12 are schematic diagrams respectively showing data content of the version management table 3a and data content of the RAM 7 in a case where the function A is changed and transferred to the control device 1. Data content of the executable files Prg1 to Prg3 in a case where the function A is changed and transferred to the control device 1 is the same as data content of the executable files Prg1 to Prg3 before the transfer.

In a case where the engineering tool 51a changes the function A of the shared library L1, the engineering tool 51a transfers the shared library L1 after the change to the control device 1. To distinguish between the shared library L1 before the change and the shared library L1 after the change, the shared library L1 before the change is hereinafter also referred to as a shared library L1, and the shared library L1 after the change is hereinafter also referred to as a shared library L2.

The code reader 2 determines whether data content of the shared library placed in the control device 1 and data content of the shared library of the engineering tool 51 before the change match. When determining that they match, the code reader 2 places the shared library after the change in the ROM 6 and updates the ROM placement information. For example, as shown in FIG. 10, the code reader 2 places the shared library L2 so that an address “0x3100” different from the starting address “0x1100” of the shared library L1 already placed in the ROM 6 becomes a starting address of the shared library L2. Both the shared libraries L1 and L2 are thus enabled.

In data content of each of the ROM 6 in FIG. 10 and the RAM 7 in FIG. 12, a three-digit number is attached to the end of each of the functions A to C to represent the version. A three-digit number “000” attached to the end of the function herein means that the function is the function of the shared library L1, and a three-digit number “001” attached to the end of the function herein means that the function is the function of the shared library L2.

While a case where the shared library (or the functions) is changed once will be described below, the shared library (or the functions) may be changed a plurality of times. In a case where the shared library (or the functions) is changed a plurality of times, the version of the shared library (or the functions) increases each time the shared library (or the functions) is changed. With the change of the function A, not only the function A after the change is placed at the address “0x3100”, but also the functions B and C before the change are placed at addresses “0x3200” and “0x3300” below, but only the function A after the change may be placed.

The version manager 3 updates the version management table 3a based on “Prg1” as a name of the executable file of the program the engineering tool 51a is responsible for and the ROM placement information. In an example of FIG. 11, the version manager 3 stores, for “Prg1” in the version management table 3a, the starting addresses “0x3100”, “0x3200”, and “0x3300” of the ROM 6 at which the functions A, B, and C of the shared library L2 to be referenced by the executable file Prg1 are placed. On the other hand. the version manager 3 maintains, for each of “Prg2” and “Prg3” in the version management table 3a, the starting addresses “0x1100”, “0x1200”, and “0x1300” of the ROM 6 at which the functions A, B, and C of the shared library L1 to be referenced by each of the executable files Prg2 and Prg3 are placed.

The loader 4 retrieves the functions A, B, and C of the shared library L2 respectively placed at the addresses “0x3100”, “0x3200”, and “0x3300” of the ROM 6 based on the name of the shared library transferred from the engineering tool 51a and the ROM placement information. The loader 4 places the functions A, B, and C of the shared library L2 in the RAM 7. For example, the loader 4 places the shared library L2 in the RAM 7 so that addresses “0xc400”, “0xc500”, and “0xc600” different from the starting addresses of the functions A, B, and C of the shared library L1 become the starting addresses of the functions A, B, and C of the shared library L2. The loader 4 also adds the addresses of the RAM 7 at which the functions A to C of the shared library L2 are placed to the jump table to update the jump table of the code of the executable file Prg1. The loader 4 also updates the RAM placement information with placement of the functions A, B, and C of the shared library L2 in the RAM 7.

### Summary of Embodiment 1

As described above, in a conventional control device, when one person changes and transfers the shared library, the other people are required to suspend their work and check the latest shared library and sometimes cannot transfer the executable files. This results in a problem in that the program cannot efficiently be developed by a plurality of people.

In contrast, according to the control device 1 according to Embodiment 1, in a case where the shared library is changed, the shared library (or the functions) after the change is held at an address different from an address of the shared library (or the functions) before the change in the ROM 6 and the RAM 7. The version manager 3 manages the address and the version of the shared library (or the functions) for each program referencing the shared library (or the functions).

According to such a configuration, a person who has changed and transferred the shared library L1 can check operation of the program the person is responsible for and the shared library L2 with reference to the shared library L2 as the shared library L1 after the change. A person who has not changed the shared library L1 can check operation of the program the person is responsible for and the shared library L1 with reference to the shared library L1 before the change.

Thus, even after one person changes and transfers the shared library, a program of another person references the shared library before the change, so that the other person can check operation and transfer the program. The one person can change the program the one person is responsible for and the shared library (or the functions) referenced by the program by transferring only the executable file of the program to the control device 1. According to the control device 1 according to Embodiment 1, the program can efficiently be developed by a plurality of people as described above.

In the above-mentioned configuration, the version of the shared library is preferably merged at a predetermined timing, for example, at the end of work of a program of each person. In particular, the versions of the functions of the same shared library are preferably merged at a timing of each person. Such a configuration enables efficient program development by a plurality of people.

### Embodiment 2

The RAM 7 of the control device 1 is finite. In view of this, according to the control device 1 according to Embodiment 2, usage of the RAM 7 can be reduced as will be described below.

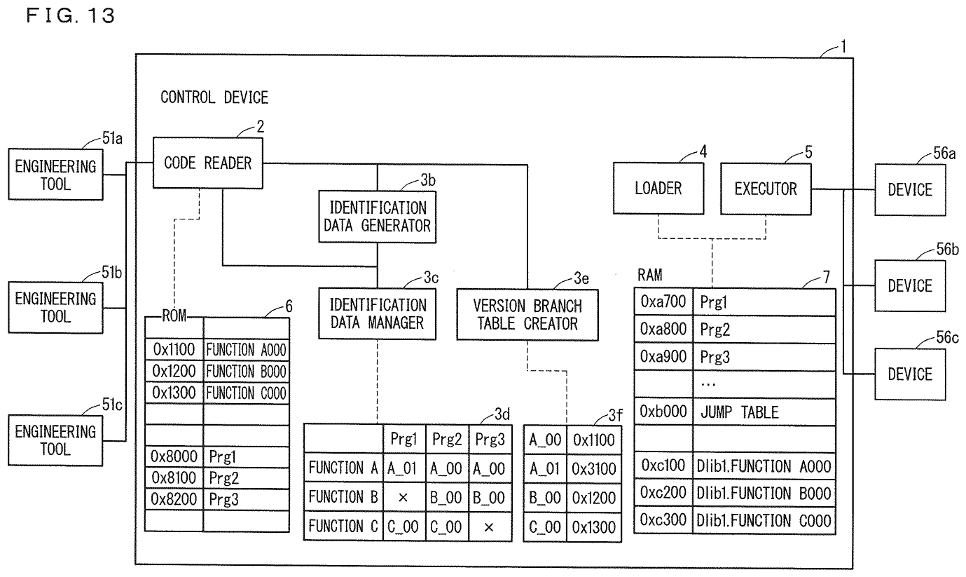

FIG. 13 is a schematic diagram showing the control device 1, the engineering tool 51, and the device 56 as a control target according to Embodiment 2. Components according to Embodiment 2 that are the same as or similar to the above-mentioned components hereinafter bear reference signs that are the same as or similar to those of the above-mentioned components, and different components will mainly be described.

The control device 1 according to Embodiment 2 includes an identification data generator 3b, an identification data manager 3c, an identification data management table 3d, a version branch table creator 3e, and a version information table 3f. The identification data generator 3b, the identification data manager 3c, and the version branch table creator 3e in FIG. 13 correspond to the version manager 3 in FIG. 5, and the identification data management table 3d and the version information table 3f in FIG. 13 correspond to the version management table 3a in FIG. 5.

The identification data generator 3b reads data of the shared library from the ROM 6 based on the name of the shared library transferred from the engineering tool $1 and the ROM placement information. The data of the shared library includes at least one of a value obtained by calculating the sum of letter codes in the code of the shared library using a hash function, a code size of the shared library, a last update date of the shared library, or a last editor of the shared library, for example.

The identification data generator 3b generates identification data enabling unique identification of a function of the shared library based on the data of the shared library and outputs the generated identification data to the identification data manager 3c and the version branch table creator 3e. Identification data of one function before the change and identification data of one function after the change are different.

The identification data manager 3c updates the identification data management table 3d based on the name of the executable file of the program the engineering tool 51 having transferred the changed shared library is responsible for, a name of each function of the shared library, and the identification data. In the identification data management table 3d, a single piece of identification data is herein associated with a pair of the name of the executable file of the program unique to the engineering tool 51 and the name of the function of the shared library. That is to say, identification data of each function of the shared library is associated with each of executable files of a plurality of programs referencing the function.

The version branch table creator 3e creates (updates) the version information table 3f based on the name of the executable file of the program the engineering tool 51 having transferred the changed shared library is responsible for, the identification data, and the ROM placement information. In the version information table 3f, an address of the ROM 6 at which the function is placed is associated with identification data of the function placed in the identification data management table 3d. Creation (update) of the version information table 3f performed by the version branch table creator 3e will be described below.

The version branch table creator 3e determines whether identification data associated with one executable file in the identification data management table 3d is associated with another executable file.

The version branch table creator 3e does nothing when determining that the identification data associated with the one executable file is associated with the other executable file, that is, when the one executable file references the same version of the function as the other executable file. On the other hand, the version branch table creator 3e associates the identification data with the ROM address after the change and adds the identification data associated with the ROM address after the change to the version information table 3f when determining that the identification data associated with the one executable file is not associated with the other executable file, that is, when the one executable file references a new version of the function.

The file name of the executable file or the shared library transferred from the engineering tool 51 and the ROM placement information are input into the loader 4 according to Embodiment 2 as in Embodiment 1.

In a case where the shared library is input, the loader 4 acquires, based on the input information, identification data of each function of the shared library from the identification data management table 3d and acquires an address of the ROM 6 of the identification data from the version information table 3f. The loader 4 determines whether the identification data is newly associated by the version branch table creator 3e based on the acquired pieces of information and the RAM placement information.

When determining that the identification data is newly associated by the version branch table creator 3e, the loader 4 places (stores) the shared library transferred from the engineering tool 51 in the RAM 7 and updates the jump table. The loader 4 writes an address of the jump table after the update into the code of the executable file of the program the engineering tool 51 is responsible for and the loader 4 updates the RAM placement information. On the other hand, when determining that the identification data is not newly associated by the version branch table creator 3e. the loader 4 does not newly place (store) the shared library transferred from the engineering tool 51 in the RAM 7.

In a case where the executable file is input, the loader 4 writes an address of the jump table into the code of the executable file so that the executable file can reference the function to be referenced based on the identification data management table 3d, the version information table 3f, and the RAM placement information. The loader 4 also changes the code and the variable data of the executable file before the change placed in the RAM 7 into the code and the variable data of the executable file after the change and updates the RAM placement information.

### Operation

Operation of the control device 1 according to Embodiment 2, that is, address management performed by the control device 1 will be described next.

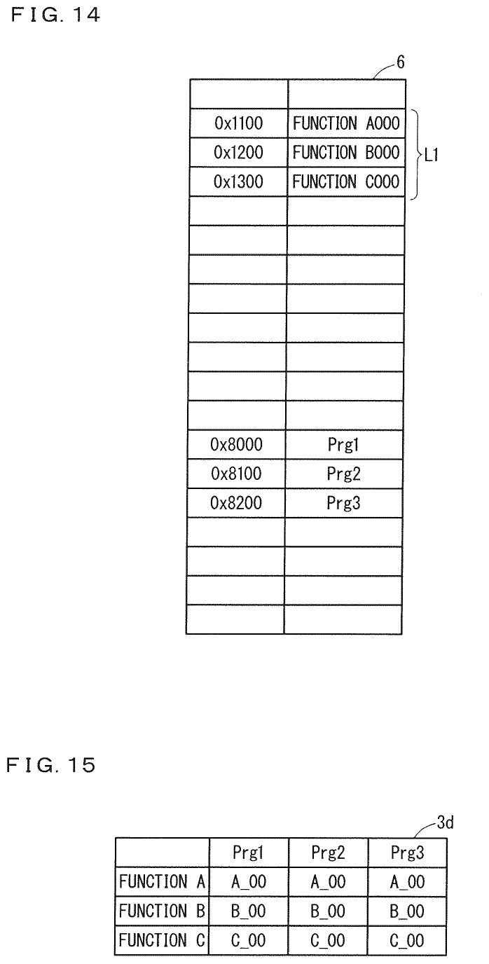

FIG. 14 is a schematic diagram showing data content of the ROM 6 in the control device 1 before online editing and is similar to FIG. 6. That is to say, before online editing, the shared library L1 before the change including the functions A to C before the change are placed in the ROM 6 with the address “0x1100” as the starting address, and the executable files Prg1, Prg2, and Prg3 are placed in the ROM 6 with the addresses “0x8000”, “0x8100”, and “0x8200” as the starting addresses.

FIG. 15 is a schematic diagram showing data content of the identification data management table 3d before online editing. As shown in FIG. 15, identification data enabling unique identification of a function to be referenced by each program is associated with each of the executable files Prg1 to Prg3 in the identification data management table 3d. The same version of the functions is to be referenced before online editing, so that one piece of identification data is associated with one function regardless of the executable files. That is to say, as in an example of FIG. 15, identification data of the function A is “A_00”, identification data of the function B is “B_00”, and the identification data of the function C is “C_00” in each of the executable files Prg1 to Prg3.

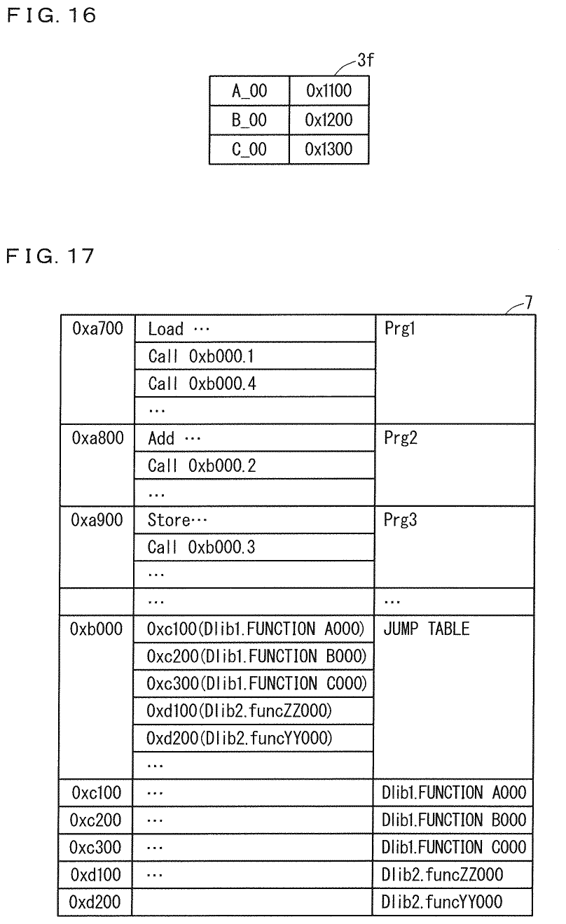

FIG. 16 is a schematic diagram showing data content of the version information table 3f before online editing. As shown in FIG. 16, in the version information table 3f, identification data of the function of the shared library is associated with the starting address of the ROM 6 at which the function is placed.

FIG. 17 is a schematic diagram showing data content of the RAM 7 in the control device 1 before online editing and is similar to FIG. 9.

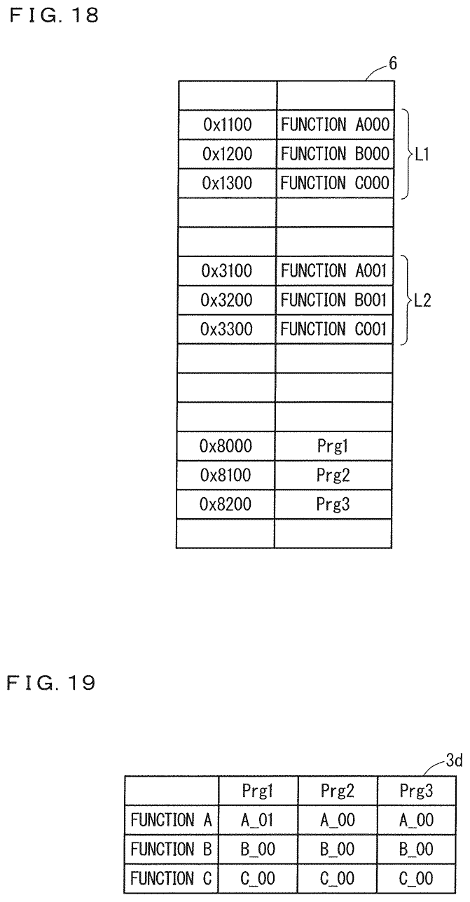

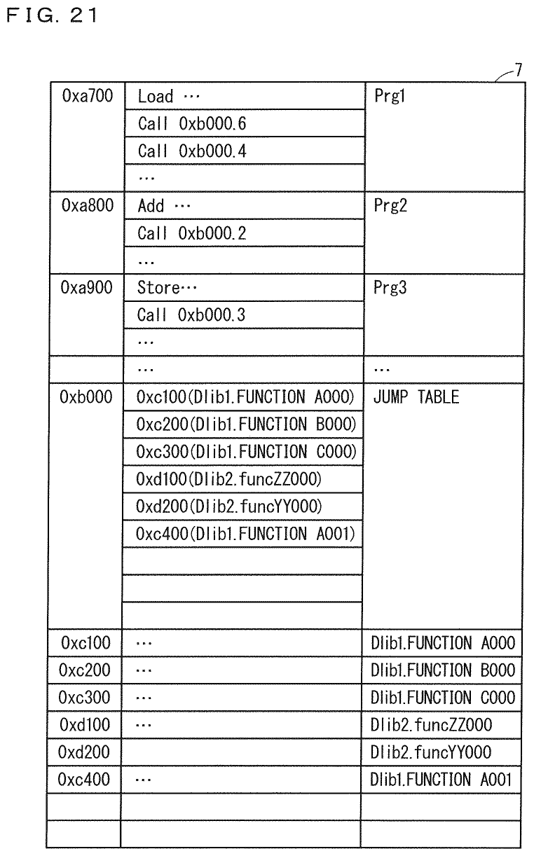

FIG. 18 is a schematic diagram showing data content of the ROM 6 in a case where the engineering tool 51a changes the function A of the shared library L1 and transfers the changed function A to the control device 1. FIGS. 19, 20, and 21 are schematic diagrams respectively showing data content of the identification data management table 3d, data content of the version information table 3f, and data content of the RAM 7 in this case.

In a case where the engineering tool 51a changes the function A of the shared library L1, the engineering tool 51a transfers the shared library L2 as the shared library L1 after the change to the control device 1.

The code reader 2 determines whether data content of the shared library placed in the control device 1 and data content of the shared library of the engineering tool 51a before the change match. When determining that they match, the code reader 2 places the shared library after the change in the ROM 6 and updates the ROM placement information. For example, as shown in FIG. 18, the code reader 2 places the shared library L2 so that the address “0x3100” different from the starting address “0x1100” of the shared library L1 already placed in the ROM 6 becomes the starting address of the shared library L2. Both the shared libraries L1 and L2 are thus enabled.

The identification data generator 3b generates, for each function of the shared library L1, the identification data enabling unique identification of the function based on the name of the shared library transferred from the engineering tool 51 and the ROM placement information. For example, the identification data generator 3b generates the identification data using the value obtained by calculating the sum of letter codes in the code of the shared library using the hash function as described above.

A case where identification data “A_01” is generated for the function A having been changed, and identification data “B_00” and identification data “C_00” that are the same as those before online editing are respectively generated for the function B and the function C not having been changed will be described below. The identification data generator 3b outputs the names of the functions (the functions A, B, and C) and identification data (“A_01”, “B_00”, and “C_00”) for the functions A, B, and C to the identification data manager 3c and the version branch table creator 3e.

The identification data manager 3c updates the identification data management table 3d based on input of the name of the executable file of the program the engineering tool 51a is responsible for, the name of each function of the shared library, and the identification data. In an example of FIG. 19, the identification data manager 3c stores the identification data “A_01” for the function A of the shared library L2 after the change to be referenced by the executable file Prg1 in “Prg1” of the identification data management table 3d and maintains the other pieces of identification data as they are.

The version branch table creator 3e determines whether identification data associated with one executable file in the identification data management table 3d is associated with another executable file based on the name of the executable file of the program the engineering tool 51a is responsible for and the ROM placement information.

When determining that the identification data is associated with the other executable file, the version branch table creator 3e associates the identification data with the ROM address after the change and adds the identification data associated with the ROM address after the change to the version information table 3f.

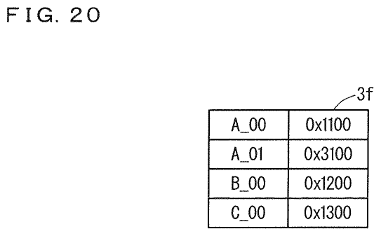

In the identification data management table 3d in FIG. 19, the identification data “A_01” for the function A associated with “Prg1” is not associated with “Prg2” and “Prg3”. The version branch table creator 3e thus associates the identification data “A_01” with the address “0x3100” of the ROM 6 of the function A after the change and adds the identification data “A_01” associated with the address “0x3100” to the version information table 3f as shown in FIG. 20. Although not shown, the version branch table creator 3e does nothing in a case where the identification data “A_01” for the function A associated with “Prg1” is associated with “Prg2” and “Prg3”.

The loader 4 acquires the identification data “A_01”, the identification data “B_00”, and the identification data “C_00” for the functions A, B, and C included in the shared library L2 from the identification data management table 3d based on the name of the shared library transferred from the engineering tool 51a and the ROM placement information. The loader 4 determines whether the identification data “A_01”, the identification data “B_00”, and the identification data “C_00” are each newly associated by the version branch table creator 3e. In an example of FIG. 20, the identification data “A_01” is newly associated by the version branch table creator 3e, so that the Joader 4 places the shared library transferred from the engineering tool 51a in the RAM 7 and updates the jump table. The loader 4 writes an address of the jump table after the update into the code of the executable file Prg1 of the program the engineering tool 51a is responsible for and the loader 4 updates the RAM placement information. Although not shown, in a case where the identification data “A_01”, the identification data “B_00”, and the identification data “C_00” are each not newly associated in the version information table 3f by the version branch table creator 3e, the loader 4 does not newly store the function A after the change in the RAM 7.

### Summary of Embodiment 2

According to Embodiment 2 as described above, in a case where the identification data generated by the identification data generator 3b is not newly associated by the version branch table creator 3e, the function (or the shared library) is not newly stored in the RAM 7. According to such a configuration, when the same version of the function (or the shared library) is transferred, the same version of the function (or the shared library) is not stored in the RAM 7, so that usage of the RAM 7 can be reduced.

### Embodiment 3

Unexpected operation sometimes occurs when a running control program is different from an assumed control program. To suppress such operation, the control device 1 reads the control program, and a change is made with the control program as a starting point during online editing.

In a case where there are two or more different versions of the shared library in the control device 1, however, it is contemplated that the latest version of the shared library is read during online editing to cause the running control program to be different from the assumed control program. Whether programs of a plurality of people reference the same version of the shared library can thus preferably be checked after completion of online editing by all the plurality of people. In view of this, according to the control device 1 according to Embodiment 3, whether the programs of the plurality of people reference the same version of the shared library can be checked as described below.

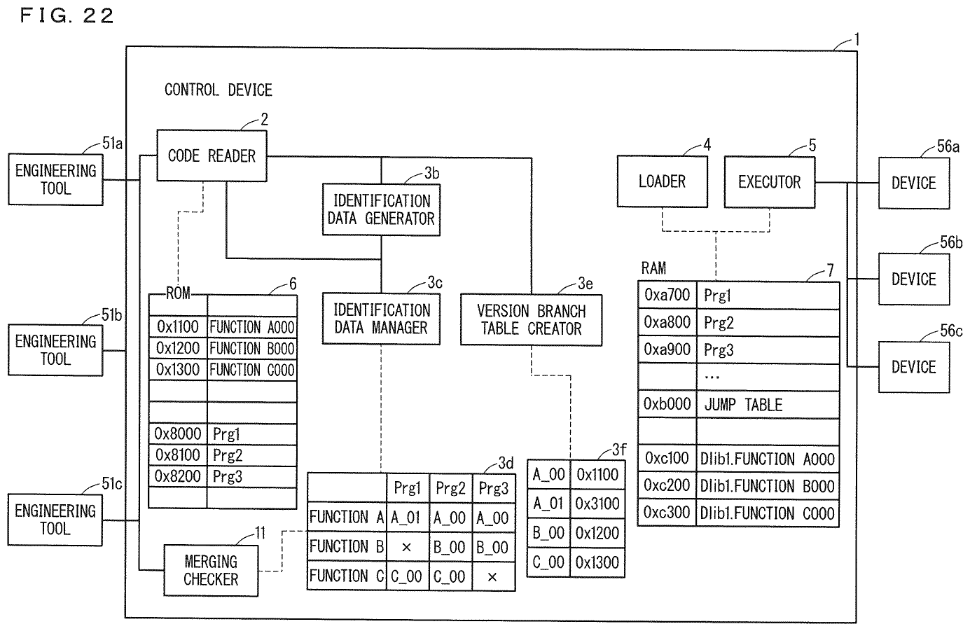

FIG. 22 is a schematic diagram showing the control device 1, the engineering tool 51, and the device 56 as a control target according to Embodiment 3. Components according to Embodiment 3 that are the same as or similar to the above-mentioned components hereinafter bear reference signs that are the same as or similar to those of the above-mentioned components, and different components will mainly be described.

A configuration of the control device 1 according to Embodiment 3 is similar to a configuration in FIG. 13 to which a merging checker 11 has been added.

In a case where at least one of the identification data or the starting address of each function in the identification data management table 3d is the same among a plurality of programs, the merging checker 11 determines that the plurality of programs reference the same version of the shared library (or the function). The merging checker 11 determines that the plurality of programs reference different versions of the shared library (or the function) in the other cases. The determination may be made at a timing of a request from the engineering tool 51 or a timing of a transfer of the executable file from the engineering tool 51, for example.

The merging checker 11 outputs completion of merging to the engineering tool 51 when determining that the same version is referenced and outputs incompletion of merging to the engineering tool 51 when determining that the same version is not referenced.

According to the control device 1 according to Embodiment 3 as described above, the merging checker 11 determines whether the plurality of programs reference the same version of the shared library (or the function). Whether programs of a plurality of people reference the same version of the shared library can thus be checked after completion of online editing by the plurality of people, for example.

### Embodiment 4

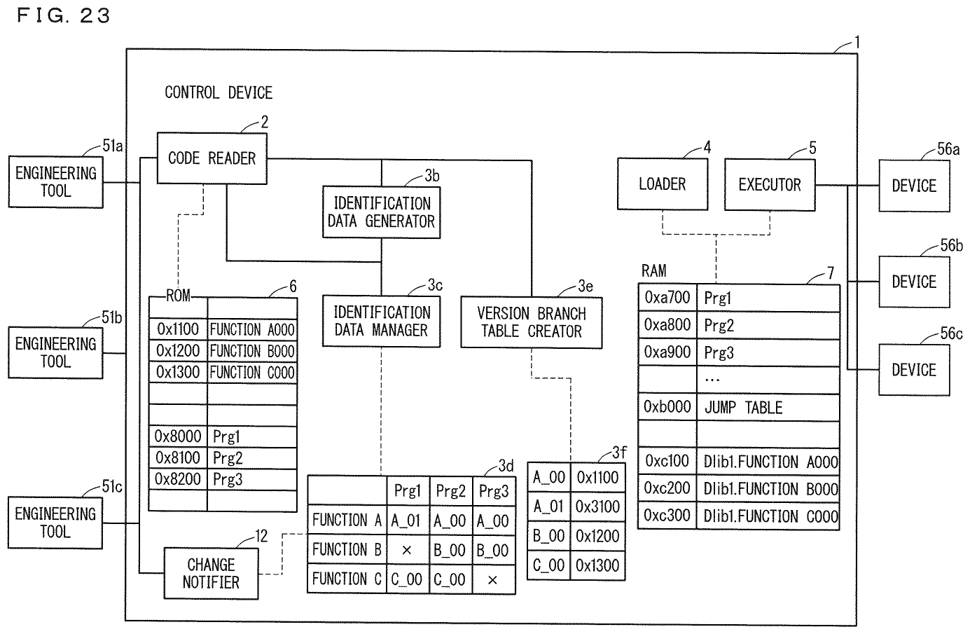

FIG. 23 is a schematic diagram showing the control device 1, the engineering tool 51, and the device 56 as a control target according to Embodiment 4. Components according to Embodiment 4 that are the same as or similar to the above-mentioned components hereinafter bear reference signs that are the same as or similar to those of the above-mentioned components, and different components will mainly be described.

A configuration of the control device 1 according to Embodiment 4 is similar to the configuration in FIG. 13 to which a change notifier 12 has been added.

The identification data manager 3c outputs names of the executable file and the shared library updated in the identification data management table 3d to the change notifier 12 when receiving the file name of the shared library and the ROM placement information from the code reader 2 as input. The change notifier 12 outputs the names of the executable file and the shared library from the identification data manager 3c to all the engineering tool 51 connected to the control device 1. That is to say, in a case where one engineering tool 51 changes the shared library (or the function), the change notifier 12 notifies the other engineering tool 51 of the change of the shared library (or the function).

According to the control device 1 according to Embodiment 4 as described above, in a case where one person changes and transfers the shared library (or the function), the change notifier 12 can automatically notify the other people. The other people can thus timely receive the notification of the change of the shared library (or the function) and thus can update the shared library (or the function) at their timings.

### Embodiment 5

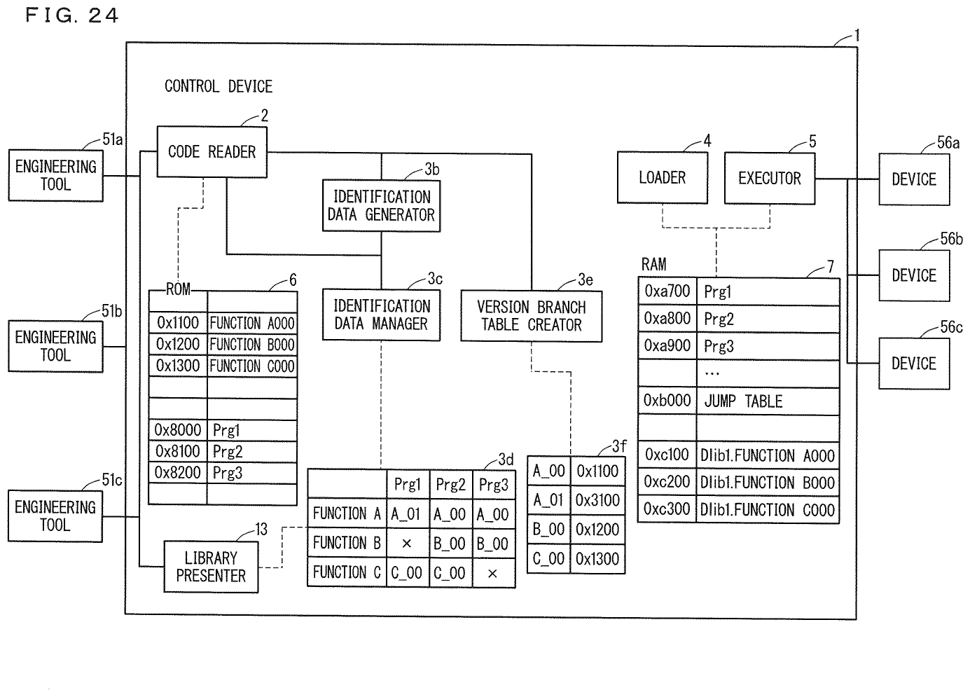

FIG. 24 is a schematic diagram showing the control device 1, the engineering tool 51, and the device 56 as a control target according to Embodiment 5. Components according to Embodiment 5 that are the same as or similar to the above-mentioned components hereinafter bear reference signs that are the same as or similar to those of the above-mentioned components, and different components will mainly be described.

A configuration of the control device 1 according to Embodiment 5 is similar to the configuration in FIG. 13 to which a library presenter 13 as a presenter has been added.

When the name of the executable file is input into the library presenter 13, the library presenter 13 acquires identification data for each function referenced by the executable file whose name is input from the identification data management table 3d and acquires a starting address of the identification data from the version information table 3f. The library presenter 13 acquires the code of the shared library from the ROM 6 based on the starting address and outputs the acquired code to each engineering tool 51. That is to say, in a case where the engineering tool 51 specifies one of the plurality of programs, the library presenter 13 presents information on the shared library referenced by the one program to each engineering tool 51.

According to the control device 1 according to Embodiment 5 as described above, the library presenter 13 can transfer the latest version of the shared library to the engineering tool 51. Each person can thus merge the latest version of the shared library in the control device 1 and a version of the shared library referenced by the person to enable more efficient program development by the plurality of people. In a case where the engineering tool 51 specifies one of the plurality of programs, the library presenter 13 may not present the information on the shared library but may present information on the function referenced by the one program to each engineering tool 51.

Embodiments and modifications can freely be combined with each other and can be modified or omitted as appropriate.

The foregoing description is in all aspects illustrative and not restrictive. It is understood that numerous unillustrated modifications can be devised.

### EXPLANATION OF REFERENCE SIGNS

1 control device, 3 version manager, 3b identification data generator, 3e version branch table creator, 4 loader, 6 ROM, 7 RAM, 11 merging checker, 12 change notifier, 13 library presenter, 51, 51a, 51b, 51c engineering tool, 51, 56a, 56b, 56c device, L1, L2 shared library, Prg1, Prg2, Prg3 executable file.

1. A control device that controls a control target according to a control program including a plurality of programs, the control device comprising:
a first memory to store, in a case where a reference target is changed, the reference target after the change at a second address different from a first address of the reference target before the change, the reference target being a function or a library referenced by the plurality of programs; and
processing circuitry configured as a version manager to associate and manage the first address or the second address with each of the plurality of programs based on whether each of the plurality of programs is to reference the reference target before the change or the reference target after the change.

2. The control device according to claim 1, wherein
the version manager includes:
an identification data generator to generate identification data associated with each of the plurality of programs based on data of the reference target; and
a version branch table creator to associate the first address or the second address with the identification data, and
the control device further comprises:
a second memory: and
processing circuitry configured as a loader not to newly store the reference target in the second memory in a case where the identification data generated by the identification data generator is not newly associated by the version branch table creator.

3. The control device according to claim 1 further comprising
processing circuitry configured as a merging checker to determine whether the plurality of programs reference the same version of the reference target.

4. The control device according to claim 1 further comprising
processing circuitry configured as a change notifier to notify, in a case where one engineering tool changes the reference target, another engineering tool of the change of the reference target.

5. The control device according to claim 1 further comprising
processing circuitry configured as a presenter to present, in a case where an engineering tool specifies one of the plurality of programs, information on the reference target referenced by the one program to the engineering tool.

6. An address management method for use in a control device that controls a control target according to a control program including a plurality of programs, the address management method comprising:
storing, in a case where a reference target is changed, the reference target after the change at a second address different from a first address of the reference target before the change by a first memory, the reference target being a function or a library referenced by the plurality of programs; and
associating and managing the first address or the second address with each of the plurality of programs based on whether each of the plurality of programs is to reference the reference target before the change or the reference target after the change.

7. The control device according to claim 2 further comprising
processing circuitry configured as a merging checker to determine whether the plurality of programs reference the same version of the reference target.

8. The control device according to claim 2 further comprising
processing circuitry configured as a change notifier to notify, in a case where one engineering tool changes the reference target, another engineering tool of the change of the reference target.

9. The control device according to claim 3 further comprising
processing circuitry configured as a change notifier to notify, in a case where one engineering tool changes the reference target, another engineering tool of the change of the reference target.

10. The control device according to claim 2 further comprising
processing circuitry configured as a presenter to present, in a case where an engineering tool specifies one of the plurality of programs, information on the reference target referenced by the one program to the engineering tool.

11. The control device according to claim 3 further comprising
processing circuitry configured as a presenter to present, in a case where an engineering tool specifies one of the plurality of programs, information on the reference target referenced by the one program to the engineering tool.
